(19) United States
(12) Patent Application Publication
(10) Pub. No.: US 2020/0401160 A1
(43) Pub. Date: Dec. 24, 2020

(54) Intelligent Autonomous Convoy Control

(71) Applicant: Alberto Daniel Lacaze, Potomac, MD (US)

(72) Inventor: Alberto Daniel Lacaze, Potomac, MD (US)

(73) Assignee: Alberto Daniel Lacaze, Gaithersburg, MD (US)

(21) Appl. No.: 16/446,778

(22) Filed: Jun. 20, 2019

(51) Int. Cl. G05D 1/02; G08G 1/00; B60W 30/16; B60W 30/18

(52) U.S. Cl. CPC G05D 1/0293; G05D 1/0295; G05D 1/0088; B60W 30/16; B60W 30/18163; G08G 1/22

(57) ABSTRACT

A convoy of trucks can save fuel by drafting, following at small vehicle separations. Autonomous vehicles can follow much closer than human driven vehicles, in the sub meter spacing. A problem with this is that it can create a moving wall that blocks other traffic. For example, a convoy in the right lane of a two-lane highway could block a car in the left lane from exiting. If there was sufficient space in between the convoying trucks, the car could merge in between two trucks and then exit. Unfortunately, this larger spacing diminishes the benefits of drafting. The present invention involves a system for convoying autonomous vehicles that changes separation distances depending on the behavior of the surrounding autonomous vehicles comprising two or more autonomous systems, a set of sensors that allows it to sense its environments, other autonomous vehicles, their position, and their velocities and a control system that uses the location of the surrounding autonomous vehicles to adjust the convoy distance.

### CROSS-REFERENCES TO RELATED APPLICATIONS

Not applicable.

### BACKGROUND OF THE INVENTION

### 1. Field of the Invention

The invention discussed here in this patent application involves a system for convoying vehicles that changes separation distances depending on the behavior of the surrounding vehicles that comprises two or more autonomous systems, a set of sensors that allows it to sense its environments, other vehicles, their position, and their velocities and a control system that uses the location of the surrounding vehicles to adjust the convoy distance.

### 2. Description of Related Art

The statements in this section merely provide background information related to the present disclosure and may not constitute prior art.

There have not been any reports in the patent literature about a system for convoying vehicles that changes separation distances depending on the behavior of the surrounding vehicles.

There has been a method and system developed for enabling semi-autonomous or autonomous vehicle travel which involves creating dedicated travel lanes for vehicle travel, determining the location of vehicles in the dedicated travel lanes and providing instructions to the vehicles in the dedicated travel lanes to enable them to travel in such a manner that they can achieve maximum speed. A vehicle travel management system is arranged in each autonomous vehicle to determine the location of the autonomous vehicles with a GPS based positioning system. This invention is disclosed in U.S. Pat. No. 7,979,172. It is worth noting that this system does not involve changing separation distances based on the behavior of the surrounding vehicles.

An autonomous controller has been developed for autonomous vehicles which has a processor configured to receive position signals from position sensors and to generate operation control signals with an updated travel path for the autonomous vehicle. The processor and programmable interface are a self-contained unit that is configurable for operation with a variety of different remote sensors and different remote operation control mechanisms. This invention is disclosed in US Patent Application No. 20140214259. It is worth noting that in this patent application, the system also does not involve changing separation distances based on the behavior of the surrounding vehicles as described in the present invention.

Another invention in the patent literature discloses an autonomous neighborhood vehicle controllable through a neighborhood social network. In one case, the autonomous neighborhood vehicle can autonomously navigate to a location determined by the user of the neighborhood social network. This invention is disclosed in U.S. Pat. No. 9,373,149 and it is worth noting that which this system involves navigation of the vehicles to a particular location, it does not involve changing the separation distances based on the behavior of the surrounding vehicles.

Overall, there have been no reports in the patent literature of autonomous vehicles which changes separation distances between the vehicles based on the behavior of the surrounding autonomous vehicles.

### SUMMARY OF THE INVENTION

A convoy of trucks can save a lot of fuel by drafting and following at small vehicle separations. Autonomous vehicles can follow much closer than human driven vehicles and even in the sub meter spacings. A problem with this level of closeness in the vehicles in the convoy is that it can create a moving wall that blocks other traffic from being able to merge into the lane or to exit the highway. For example, a convoy in the right lane of a two-lane highway could block a car in the left lane from exiting. If there was sufficient space in between the convoying autonomous vehicles, the car could merge in between two autonomous vehicles and then exit. Unfortunately, this larger spacing diminishes the benefits of drafting and there has to be a compromise between the two parameters.

The present invention involves convoying autonomous vehicles that changes separation distances depending on the behavior of the surrounding autonomous vehicles. It comprises two or more autonomous systems, a set of sensors that allow it to sense its environments, other vehicles, their position, and their velocities, and a control system that uses the location of the surrounding vehicles to adjust the convoy distances.

### BRIEF DESCRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIG. 1—Convoy controller commands tight spacing to minimize fuel consumption when alone.

FIG. 2—If other traffic is present, convoy controller opens a gap(s) to allow other traffic to merge in order for the other traffic to enter or exit in the highway. The gap(s) may vary in size depending on the type and size of the merging vehicle and highway conditions.

FIG. 3—Convoy controller commands tight spacing when there is no need for other traffic to merge.

FIG. 4—When changing lanes in heavy traffic, the convoy controller first commands the rear vehicle to change lanes, when clear. Then the next vehicle changes lanes, and so on.

FIG. 5—In heavy traffic, the convoy controller may break large convoys into multiple smaller convoys or dissolve convoying altogether. When traffic becomes lighter, individual vehicles and smaller convoys can merge.

FIG. 6—Convoy controller may use onboard sensors to detect the location and speed of the other vehicles or it can receive the information from a smart highway or directly from the other vehicles.

FIG. 7—Convoy controller may command vehicles to maintain spacing as if the following vehicles were being towed. In this case, all vehicles will drive at the same speed as the leader. The leader will go slow until all vehicles have cleared the restricted area such as an intersection or toll plaza.

FIG. 8—If other traffic is intermingled in the convoy, convoy controller may slow the convoy to encourage the intermingled traffic to change lanes.

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

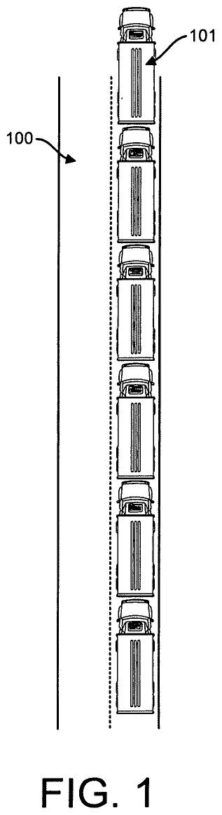

FIG. 1 illustrates the convoy controller commanding tight spacing to minimize fuel consumption when alone without the presence of other traffic. The autonomous convoy is shown in 101 and the road network is shown in 100.

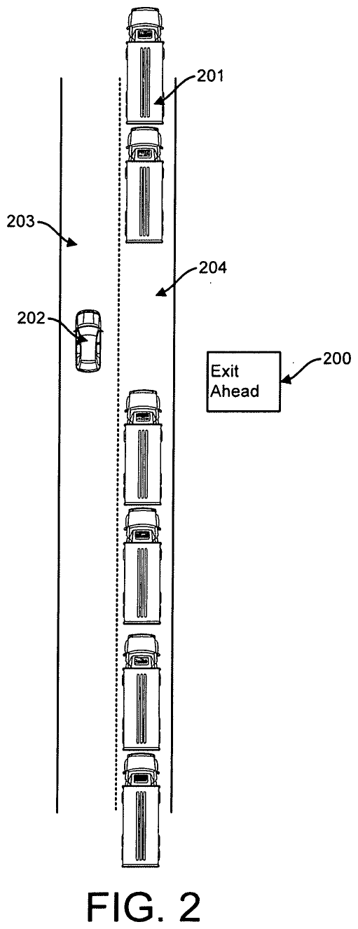

FIG. 2 illustrates the convoy controller opening a gap(s) to allow other traffic to merge when there are other traffic present in order for the other traffic to enter or exit the highway. The gap(s) may vary in size depending on the type and size of the merging vehicle such as a smaller gap for a car than a truck and also based on the highway conditions and weather conditions. In this case, there is an exit that is directly ahead, so it is important for traffic to be able to merge with enough gap between the autonomous vehicles in the convoy. In this figure, it can be seen that there is a car in the first lane (203) of the road network which needs to merge into the second lane (204) of the road network where the autonomous vehicles (201) are located at. There is a gap between the autonomous vehicles (100) which allows the vehicle (202) in the first lane (203) to merge into the second lane (204) and proceed to exit the highway via the exit ahead (200).

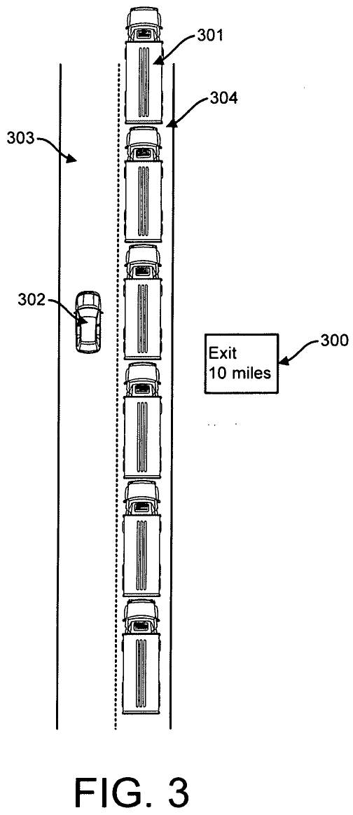

In FIG. 3, the convoy controller commands tight spacing when there is no need for other traffic to merge since in this case, the exit is 10 miles away (300). Since the exit is so far ahead, there is no need for the vehicle (302) in the first lane (303) to merge into the second lane (304) of the road network containing the autonomous vehicles (301) in the immediate future. This process can take place once the autonomous vehicles approach much closer to the exit like in the case of FIG. 2.

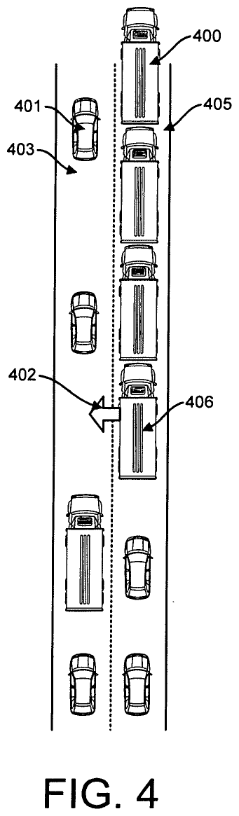

As can be seen in FIG. 4, when changing lanes in heavy traffic, the convoy controller first commands the rear vehicle to change lanes, when clear. Then the next vehicle changes lane, and so on. In this figure, it can be seen that there is a group of autonomous vehicles (400) in the second lane (405) as well as two autonomous vehicles (401, 404) in the first lane (403). The convoy controller then commands a rear autonomous vehicle (406) to change lanes from the second lane (405) to the first lane (403), when the first lane (403) is clear without the presence of other autonomous vehicles.

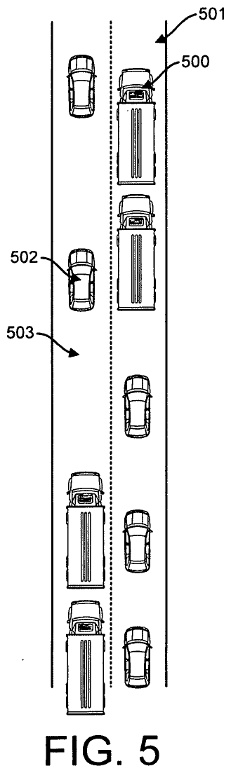

FIG. 5 shows the convoy controller breaking large convoys into multiple smaller convoys or dissolve convoying altogether in heavy traffic. When the traffic becomes lighter, individual vehicles and smaller convoys can merge back together to form a larger convoy. In the figure, it can be seen that the during heavy traffic, there are individual vehicles (502) and smaller convoys (500) present in both the first and second lane (501, 503) of the road network.

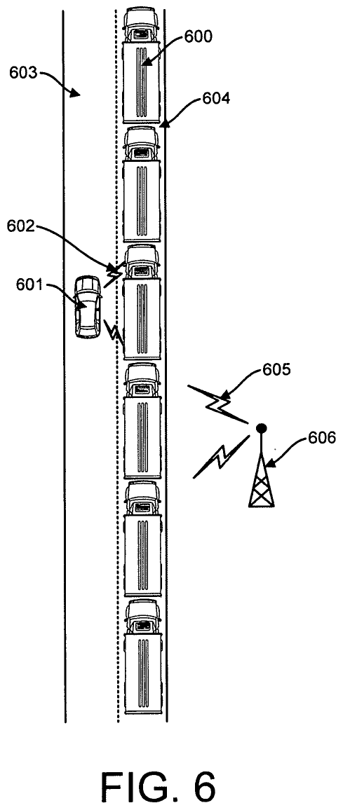

FIG. 6 shows the convoy controller using onboard sensors to detect the location and speed of the other vehicles or receiving the information from a smart highway or directly from the other vehicles. This is illustrated in the figure where there is a convoy of autonomous vehicles (600) where there is a communication mechanism (601) between the sensor suite of one autonomous vehicle in the second lane (604) to that of another autonomous vehicle (601) in the first lane (601). It can also receive the information from a smart highway (606) through a communication mechanism (605).

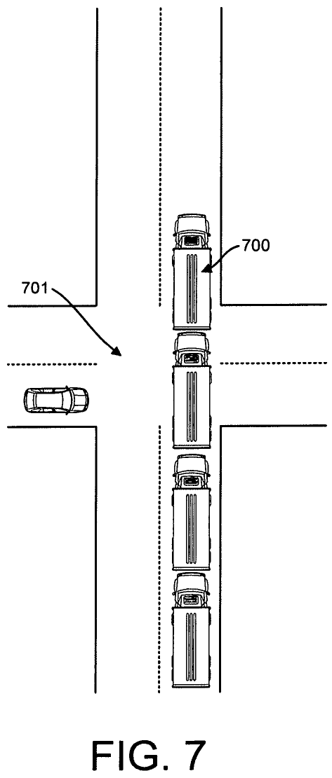

FIG. 7 shows the convoy controller commanding vehicles to maintain spacing as if the following vehicles were being towed. Here, all the autonomous vehicles drive at the same speed as the leader and the leader will go slow until all vehicles have cleared the restricted area such as an intersection or a toll plaza. In this figure, it can be seen that the autonomous vehicles (700) follow each other closely and drive at the same speed as the lead autonomous vehicle. The slow speed by the leader continues until all of the vehicles have cleared the intersection (701) in the road network (702).

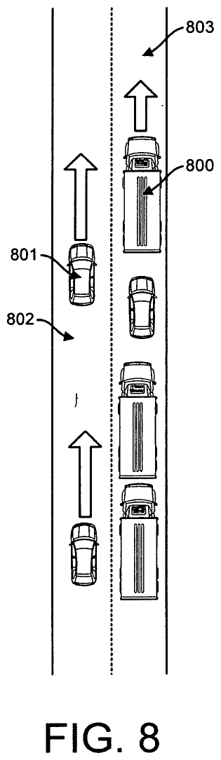

In FIG. 8, if other traffic is intermingled in the convoy, the convoy controller may slow the convoy to encourage the intermingled traffic to change lanes. This figure shows the autonomous vehicles (800) in the second lane (803) slowing down while the autonomous vehicles (801) in the first lane (802) pick up speed to allow the possibility to change lanes.

A convoy of trucks can save fuel by drafting, following at small vehicle separations. Autonomous vehicles can follow much closer than human driven vehicles, in the sub meter spacing. A problem with this is that it can create a moving wall that blocks other traffic. For example, a convoy in the right lane of a two-lane highway could block a car in the left lane from exiting. If there was sufficient space in between the convoying trucks, the car could merge in between two trucks and then exit. Unfortunately, this larger spacing diminishes the benefits of drafting requiring a compromise to be found.

The present invention involves a system for convoying vehicles that changes separation distances depending on the behavior of the surrounding vehicles comprising two or more autonomous ground vehicles, a set of sensors in each vehicle that allow it to sense its environments such as their position on the road and other vehicles including their positions and their velocities.

This particular system contains a control system that senses highway exits and automatically increases separation distances if there are surrounding vehicles that are attempting to exit the highway. The control system does not sense the road exits, but instead, it is aware of the exits from an a-priori road map.

In this system, the vehicles can detect other vehicles' signals and increase the separation distances in the cases where the other traffic is attempting to merge. Also, the positions of other vehicles are determined by the connected highway or are directly communicated to the convoy from the vehicles. In this system, the convoy maintains short separation distances around road exits if there are no vehicles to continue drafting.

In this system, the control system on the leading part of the convoy slows down to encourage vehicles that are intermingled in the convoy to switch lanes and re-establish the convoy with no other vehicles intermingled. Also, the control system in the vehicles purposely adjust the speed to deny other vehicles from intermingling with the convoy. This is accomplished by either slowing down the leaders or speeding up the followers and decreasing the gaps to deny other vehicles from intermingling.

The control systems of the leader autonomous vehicle obey a stop sign, but other autonomous vehicles in the convoy moves in a synchronized manner and other autonomous vehicles in the convoy maintain separation distances through a toll booth or stop sign. The control system maintains separation distances when the complete convoy decides to change lanes. The control system also changes the separation distances depending on speed, terrain types, and/or weather conditions.

In this system, the control system uses separation distances to allow other traffic to intermingle with the convoy, within a limit. If these separation distance thresholds are exceeded, the control system in the lead autonomous vehicle will slow down to decrease separation distances. The last autonomous vehicle in the convoy changes lanes first, blocking faster traffic to allow the second to last vehicle to change lanes. This process is repeated several times until all the autonomous vehicles in the road network have changed lanes.

In this system, the control system maintains separation distances even if autonomous vehicles are in different traffic lanes. Also, the control system on the autonomous vehicles changes separation distances when sensing that other autonomous vehicles are attempting to merge into the lane currently being used by the convoy. The control system also increases separation distances when dust is present to mitigate sensor exposure to dust.

The control system senses that an autonomous vehicle wants to merge into the lane where the convoy is operating, and it signals the autonomous vehicle that it is okay to merge once there is enough separation to do so. The control system in the convoy vehicle are made larger or smaller depending on the type of merging autonomous vehicle. For example, trucks and buses may create larger gaps compared to cars and motorcycles. The control system can be commanded by an operator to allow only a certain type of autonomous vehicle to merge. For example, only cars and motorcycles can merge, but trucks and buses cannot. Also, the control system can only allow for merging when correct signaling is used and there is an upcoming exit.

In the system, the autonomous vehicles can also be manual or semiautonomous.

In heavy traffic, the convoy controller may break up large convoys into multiple smaller convoys or dissolve convoying altogether. When the traffic becomes lighter, the individual vehicles and smaller convoys can then merge back to form the larger convoys.

The embodiments of the invention in which an exclusive property or privilege is claimed are defined as follows:

1. A system for convoying autonomous vehicles that changes separations distances depending on the behavior of the surrounding autonomous vehicles comprising:
two or more autonomous ground vehicles;
a set of sensors that allow it to sense its environments and position on the road, other autonomous vehicles and their position and their velocities and;
a control system that uses the location of the surrounding autonomous vehicles to adjust the convoy inter-vehicle spacing.

2. The system of claim 1 wherein the control system senses exits of the highway and automatically increases separation distances if there are surrounding vehicles that are attempting to exit.

3. The system of claim 1 wherein the control system does not sense the road exits, but instead is aware of the exits from an a-priori road map.

4. The system of claim 1 wherein the vehicles can detect other vehicles' signals and increase the separation distances when other traffic is attempting to merge.

5. The system of claim 1 wherein the positions of other vehicles are determined by the connected highway or are directly communicated to the convoy from the vehicles.

6. The system of claim 1 wherein the convoy maintains short separations around road exits if there are no vehicles around to continue drafting.

7. The system of claim 1 wherein the control system on the leading part of the convoy slows down to encourage vehicles that are intermingled in the convoy to switch lanes and re-establish the convoy with no other vehicles intermingled.

8. The system of claim 1 wherein the control system in the vehicles purposely adjust the speed to deny other vehicles from intermingling with the convoy by slowing down the leaders or speeding up the followers and therefore decreasing the gaps and denying others from intermingling.

9. The system of claim 1 wherein the control systems of the leader vehicle will obey a stop sign, but other vehicles in the convoy will move in a synchronized manner and other vehicles in the convoy will maintain separation distances without obeying the stop sign.

10. The system of claim 1 wherein the control system of the leading vehicles will slow down in order for the convoy to maintain separation distances though a toll booth or stop signs.

11. The system of claim 1 wherein the control system maintains separation distances when the complete convoy decides to change lanes.

12. The system of claim 1 wherein the control system changes the separation distances depending on speed, terrain types, and/or weather conditions.

13. The system of claim 1 wherein the control system uses separation distances to allow other traffic to intermingle with the convoy within a limit.

14. The system of claim 1 wherein if those separation distance thresholds are exceeded, the control system in the lead vehicle will slow down to decrease separation distances.

15. The system of claim 1 wherein the last vehicle in the convoy changes lanes first, blocking faster traffic to allow the second to last vehicle to change lane and the process is repeated until all vehicles have changed lanes.

16. The system of claim 1 wherein the control system maintains separation distances even if vehicles are in different traffic lanes.

17. The system of claim 1 wherein the control system on the vehicles changes separation distances when sensing that other traffic vehicles are attempting to merge into the lane currently being used by the convoy.

18. The system of claim 1 wherein the control system increases separation when dust is present to mitigate sensor exposure to dust.

19. The system of claim 1 where the control system senses that a vehicle wants to merge into the lane where the convoy is operating, and it signals the vehicle that it is ok to merge once there is enough separation to do so.

20. The system of claim 1 where the control system in the convoy vehicle is made larger or smaller depending on the type of merging vehicle, in which trucks and buses may create larger gaps.

21. The system of claim 1 wherein the control system can be commanded by an operator only to allow a certain type of vehicle to merge such as allowing only cars and motorcycles to merge, but trucks cannot merge.

22. The system of claim 1 wherein the control system can only allow for merging when correct signaling is used, and there is an upcoming exit.

23. The system of claim 1 wherein the autonomous vehicles are manual or semiautonomous.

24. The system of claim 1 wherein the convoy controller may break large convoys into multiple smaller convoys or dissolve convoying altogether in heavy traffic and when traffic becomes lighter, individual vehicles and smaller convoys can merge back.
